(19) United States
(12) Patent Application Publication
(10) Pub. No.: US 2025/0181766 A1
(43) Pub. Date: Jun. 5, 2025

(54) Entity Relationship Privacy for Large Language Models

(71) Applicant: Oracle International Corporation, Redwood City, CA (US)

(72) Inventors: Virendra J. Marathe, Nashua, NH (US); Hamid Mozaffari, Amherst, MA (US); Pallika Kanani, Westford, MA (US); Archit Uniyal, Charlottesville, VA (US)

(21) Appl. No.: 18/957,477

(22) Filed: Nov. 22, 2024

Related U.S. Application Data
(60) Provisional application No. 63/604,761, filed on Nov. 30, 2023.

(51) Int. Cl. G06F 21/62; G06F 40/295

(52) U.S. Cl. CPC G06F 21/6254; G06F 40/295

(57) ABSTRACT

Systems and methods are disclosed for implementing entity-relationship privacy for machine learning models. Raw data may be used to fine-tune a large language model that has been pre-trained with publicly available data. Raw data is first modified to generate training data that provides privacy for sensitive relationships between entities. The raw data is first analyzed to identify sensitive entity relationships, where each of the sensitive entity relationships include a first entity and a second entity. Then, for each sensitive entity relationship, at least one of the first and second entities is replaced with a non-sensitive entity generated by the reference model. Then the resulting training data may be used to further train, or fine-tune, a large language model that has been pre-trained with publicly available data.

### RELATED APPLICATIONS

This application claims benefit of priority to U.S. Provisional Application Ser. No. 63/604,761, entitled “Entity Relationship Privacy for Large Language Models,” filed Nov. 30, 2023, and which is incorporated herein by reference in its entirety.

### BACKGROUND

### Field of the Disclosure

This disclosure relates generally to computer hardware and software, and more particularly to systems and methods for implementing machine learning systems.

### Description of the Related Art

Advances in Large Language Models (LLMs) have transformed the world of natural language processing. LLMs are pre-trained on vast amounts of publicly available data, giving them a solid grasp of usage of natural language in numerous contexts. Furthermore, the release of ChatGPT has brought LLMs to the forefront of society, dramatically accelerating world-wide adoption of LLMs in the computing industry.

While LLMs appear to be effective learners of natural language structure and patterns of its usage, a key contributing factor to their success is their ability to memorize training data, often in a verbatim fashion. This memorized data can be reproduced intact at inference time which effectively serves the purpose of information retrieval. For instance, one can ask the names of last five presidents of the United States and the LLM will produce correct names. However, this reproduction of training data is also at the heart of privacy concerns in LLMs as LLMs may leak training data at inference time.

### SUMMARY

Systems and methods are disclosed for implementing entity-relationship privacy for machine learning models. Raw data may be used to fine-tune a large language model that has been pre-trained with publicly available data. Raw data is first modified to generate training data that provides privacy for sensitive relationships between entities. To generate the training data from the raw data, the raw data is first analyzed to identify sensitive entity relationships, where each of the sensitive entity relationships include a first entity and a second entity. Then, for each sensitive entity relationship, at least one of the first and second entities is replaced with a non-sensitive entity generated by the reference model. Then the resulting training data may be used to further train, or fine-tune, a large language model that has been pre-trained with publicly available data.

### BRIEF DESCRIPTION OF THE DRAWINGS

FIG. 1 is a block diagram illustrating a machine learning system that provides entity-relationship privacy for large language models, in various embodiments.

FIG. 2 is a block diagram illustrating sensitive entity modification in a machine learning system that provides entity-relationship privacy for large language models, in various embodiments.

FIG. 3 is a high-level flowchart illustrating techniques for fine tuning the training of a large language model while enforcing entity-relationship privacy, according to some embodiments.

FIG. 4 is a high-level flowchart illustrating techniques for generating a training data set providing entity-relationship privacy, according to some embodiments.

FIG. 5 illustrates an example computing system, according to some embodiments.

While the disclosure is described herein by way of example for several embodiments and illustrative drawings, those skilled in the art will recognize that the disclosure is not limited to embodiments or drawings described. It should be understood that the drawings and detailed description hereto are not intended to limit the disclosure to the particular form disclosed, but on the contrary, the disclosure is to cover all modifications, equivalents and alternatives falling within the spirit and scope as defined by the appended claims. Any headings used herein are for organizational purposes only and are not meant to limit the scope of the description or the claims. As used herein, the word “may” is used in a permissive sense (e.g., meaning having the potential to) rather than the mandatory sense (e.g. meaning must). Similarly, the words “include”, “including”, and “includes” mean including, but not limited to.

Various units, circuits, or other components may be described as “configured to” perform a task or tasks. In such contexts, “configured to” is a broad recitation of structure generally meaning “having circuitry that” performs the task or tasks during operation. As such, the unit/circuit/component can be configured to perform the task even when the unit/circuit/component is not currently on. In general, the circuitry that forms the structure corresponding to “configured to” may include hardware circuits. Similarly, various units/circuits/components may be described as performing a task or tasks, for convenience in the description. Such descriptions should be interpreted as including the phrase “configured to.” Reciting a unit/circuit/component that is configured to perform one or more tasks is expressly intended not to invoke 35 U.S.C. § 112 (f) interpretation for that unit/circuit/component.

This specification includes references to “one embodiment” or “an embodiment.” The appearances of the phrases “in one embodiment” or “in an embodiment” do not necessarily refer to the same embodiment, although embodiments that include any combination of the features are generally contemplated, unless expressly disclaimed herein. Particular features, structures, or characteristics may be combined in any suitable manner consistent with this disclosure.

### DETAILED DESCRIPTION OF EMBODIMENTS

Advances in Large Language Models (LLMs) have transformed the world of natural language processing and beyond. While LLMs appear to be effective learners of natural language structure and patterns of its usage, a key contributing factor to their success is their ability to memorize their training data, often verbatim. This memorized data can be reproduced accurately at inference time which effectively serves the purpose of information retrieval. However, this reproduction of training data is also at the heart of privacy concerns in LLMs. Previous works have shown that LLMs leak some of their sensitive training data at inference time. Existing solutions either focus on employing the classic Differential Privacy (DP) formalism and related solutions, or modified versions that focus on entities in the data corpus.

Entity Relationship Differential Privacy (ErDP) captures sensitivity of data at the granularity of relationships between entities. Disclosed herein are systems and methods to enforce ErDP that use reference models in a novel way. Reference models have been used in certain membership inference attacks in the past in conjunction with the target model to determine the likelihood of membership of a target data record in the model's training dataset. Here, instead, ErDP guarantees are enforced during LLM training or fine-tuning. The reference model, first trained on non-sensitive data, may be used to generate replacements of entity tokens occurring in sensitive relationships. This technique may be applied to other forms of entity-based DP guarantees as well. The new privacy granularity more precisely captures the tokens in token sequences that need to be perturbed, or hidden, for privacy of entities in sensitive relationships.

Membership Inference Attacks (MIAs) may efficiently measure memorization in LLMs. If a training data sample (e.g. sentence, paragraph, document) is generated verbatim from the training data, then it is considered memorized (member of the training dataset). However, a privacy risk emerges only when sensitive training data is memorized and reproduced during inference. K-eidetic memorization has been proposed as an approximation to memorization of sensitive data. Assuming that a sensitive datum appears less than K times in the training dataset, its memorization would be considered a privacy risk. This turns privacy risk into an objective quantity. Correspondingly, frequency of occurrence of a sequence may serve as a proxy for data sensitivity and used memorization measurement through template-based and prompt-based inference attacks to approximate privacy risks. Additionally, memorization across token-level and document-level settings may be measured. However, privacy remains a subjective quality.

Metrics based on eidetic memorization have two restrictions. First, they build on the intuition that frequency of occurrence of a sequence can determine if a sequence is sensitive. However, frequency does not quite capture the sensitivity of data; often times, infrequently occurring data is not sensitivity. Furthermore, in domain specific tuning datasets (e.g. clinical notes datasets), sensitive information (e.g. clinical notes on a patient with a terminal disease) can occur frequently. Second, the eidetic memorization metrics are based on the extracting sequences used for training verbatim. However, natural language is rich enough to express the same sensitive data in varied forms, via various levels of indirection and associations. Verbatim memorization does not capture this semantic memorization that may occur in LLMs using sensitive training datasets.

Another technique focuses on tokens in text data that embody Personally Identifiable Information (PII). Relatedly, recent approaches target sensitive entities, and propose differentially private solutions to obfuscate mentions of such entities. The intuition here is that entity occurrences embody PII appearing in text data. Entity occurrences in text data, however, are not sensitive all the time. Consider the following sentences:
“Dr. John Smith likes cats.” “Dr.
John Smith studies leukemia.” “Dr.
John Smith has leukemia.”

The first two sentences may be considered non-sensitive while the last sentence is sensitive, its key difference from the second sentence is the “has” relation between entities “John Smith” and “leukemia”. What appears needed is privacy of sensitive relationships between entities appearing in the text data. In the degenerate case, a simple mention of an entity can also be viewed as sensitive data (e.g. data corpus containing list of leukemia patients). This can be correctly captured by the “exists” relationship between the entity and the enclosing context.

In various embodiments, differential privacy may bound the maximum impact a single data item can have on the output of a randomized algorithm, [symbol] . Thus, differential privacy may be described where randomized algorithm [symbol] : [symbol] → [symbol] is said to be (ε, δ) differentially private if for any two adjacent data sets D, D′∈ [symbol] , and set R⊆ [symbol] , [symbol] ( [symbol] (D)∈R)≤e^{∈}( [symbol] ( [symbol] (D′)∈R)+δ (equation 1) where D, D′ are adjacent to each other if they differ from each other by a single data item. δ is the probability of failure to enforce the ε privacy loss bound. The above description may provide item level privacy.

For entity-relationship privacy, the above definition may be recast in terms of entities and their sensitive relationships. An entity set E may be defined as a set of entities or objects represented as tokens in a sequence. An entity set contains public entities E_{pub} and private entities Eₚᵣᵢ:

$$E {=}^{Δ} {E}_{pub} ⋃ {E}_{pri}$$

We define a relationship as semantic connectors that connect two or more entities to form a sequence. A relationship set can further be divided into public relationships Rpub and private relationships Rpri:

$$R {=}^{Δ} {R}_{pub} ⋃ {R}_{pri}$$

We define an entity-relationship tuple as a tuple of two entities e1 and e2 from the entity set E connected via a relation r from the relationship set R.

$$ER {=}^{Δ} {e}_{1} {↔}^{r} {e}_{2}$$

We define context C as a sequence of tokens enclosing an ER tuple in a sentence. A sentence s can be represented in terms of ER tuples and a context C as follows:

$$s {=}^{Δ} ( {ER}_{1} ⋃ {ER}_{2} ⋃ {ER}_{3 ...} ⋃ {ER}_{4 \}} ⋃ C$$

D, D′∈ [symbol] are entity-relationship adjacent datasets if and only if D and D′ differ in an entity-relation tuple.

$$D = {D}^{′} ⋃ \{ er ∈ ER \}$$

D may contain multiple (potentially duplicate) instances of er.

Given a set of private entity relation tuples ERₚᵣᵢ ∈ER, and two entity-relationship adjacent datasets D and D′, a randomized algorithm [symbol] : [symbol] → [symbol] satisfies (ε, δ)−ErDP if ∀D, D′∈ [symbol] , where D=D′∪{er ∈ ERₚᵣᵢ} and ∀T⊆ [symbol] ,

$${P}_{r} [ 𝒜 ( D ) ⊆ T ] \leq {e}^{ϵ} Pr [ 𝒜 ( {D}^{′} ) ⊆ T ] + δ$$

In the past, reference models have been used successfully for membership inference attacks. They are used in conjunction with the target model T to determine the likelihood of membership of a target data record in the model's training dataset. Instead of assisting in privacy attacks, reference models may be used as a privacy risk mitigation tool.

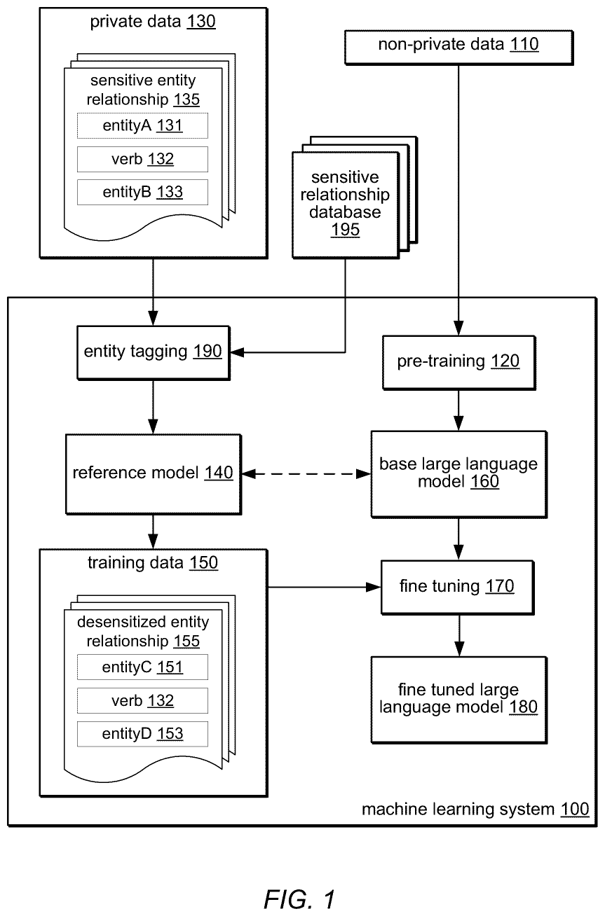

Input perturbation may be performed using a reference model R. As shown below in FIG. 1, a reference model R perturbs a sensitive token sequence to ensure privacy. The perturbed token sequence is then used to fine-tune the pre-trained target model T. This fine-tuned model is the one that is used for inference. The reference model R itself can be a model pre-trained on a large volume of public data collected from crawling the web. Furthermore, R can be pre-trained or fine-tuned on in-domain public data.

The reference model R may be a stock language model, like GPT, trained on the task of next word prediction. Without loss of generality, assume that the input string is s=<s1, e1, r, e2, s2>, where s1 is the prefix of s up to the tokens embodying the sensitive relationship r between entities e1 and e2, and s2 is the corresponding suffix of s. The method replaces entities e1 and e2 in the relationship with tokens generated by R. R is provided the string <s1> as its input to generate a new entity e′, after which the model is provided the string <s1, e′, r> to generate e′, the replacement for entity e2. Thus string s is substituted by string s′=<s1, e′, r, e′, s2> using R. This string s′ is used as an input string to train the target model T.

Note that simply replacing either e1 or e2 may also be sufficient to obfuscate the relationship <e1↔e2>. Such an approach applies to settings where appearance of PII (e.g. names of individuals) in the input string is acceptable as long as the sensitive relationship remains hidden (by replacing the other entity in the relationship). In yet other settings, replacing the tokens comprising PII of an entity (e.g. name of a person) mentioned in text may be accomplished using the reference model R.

The reference model R can also be a masked language model, like BERT, trained to predict masked words in a sequence of words (e.g. sentence). Thus the above string s is modified to s′=<s1, maske1, r, maske2, s2> that is provided as the input to the masked language model, which then generates s″=<s1, e″, r, e″, s2>. s″ is used as an input string to train model T. As shown in FIG. 1 below, a sensitive relationship “John Smith has leukemia” may be transformed to an insensitive perturbation “Bob Dunky has cold” that serves as an input to the model to be fine-tuned.

In other embodiments, the reference model R may be a language model trained or fine-tuned on the target dataset D that contains sensitive relationships between entities. D is not perturbed while training/tuning R. As a result, R could end up memorizing sensitive relationships between entities, which can be reproduced by R when queried with an appropriate prompt. We can however effectively use R to train the target model T without compromising the privacy of such sensitive relations as follows.

Consider the input string s=<s1, e1, r, e2, s2> used in training the target model T. R can be queried for the next token using the string <s1> to get a probability distribution on the vocabulary for the next word. Usually, the word with highest probability is used as the next word. Instead, in our method, we select the words with top K probabilities, and then perturb these probabilities using noise drawn from the Gaussian distribution (alternately using the Laplacian distribution). Since probabilities are bounded by the maximum value of 1, the sensitivity used to compute the noise would be 1. This method is called the Gaussian mechanism and is known to provide (ε, δ)-DP guarantee.

Yet another variation of the above algorithm uses the Exponential mechanism, which does not directly perturb the probabilities of the vocabulary words for the next token. Instead, the top K words are sorted by their probabilities in decreasing order. The probability of each word serves as the utility value of the word. The exponential mechanism then selects a word with the probability proportional to its utility with respect to utilities of all the top K words. We bound the minimum utility of each of the top K words to a threshold t>0 to avoid having just one choice in a pathological scenario where probabilities of all words, except one, are 0. This exponential mechanism is known to provide pure ε-DP guarantee.

Various tools and methods may be envisioned to precisely (or conservatively) identify sensitive entity relationships. These tools and methods may not cover all the entities in sensitive relationships in arbitrary datasets containing large volumes of unstructured data, however datasets constrained to specific domains (e.g. health care) where the vocabulary, verbiage, and language idioms are limited in scope to make identification feasible. If the sensitive dataset is small enough a manual screening to mark entities of sensitive relationships may be feasible. Simple regular expression matching can also be used to identify entities in sensitive relationships in settings where the vocabulary is constrained enough. Furthermore, natural language processing tools such as NLTK and spaCy may be used to identify entities in the dataset. Additionally, more aggressive approaches that target contextual data (e.g. nouns, pronouns, adjectives, sentence subjects and objects, etc.) may be employed to enable highly conservative perturbation of input text sequences, at the cost of degradation of model utility.

FIG. 1 is a block diagram illustrating a machine learning system that provides entity-relationship privacy for large language models, in various embodiments. A machine learning system 100 may further train or fine-tune 170 a base large language model 160 to generate a fine-tuned large language model 180, in some embodiments, where the base large language model 160 may be previously pre-trained 120 using public, non-private data 110.

In at least one embodiment, non-private data 110 may exclude sensitive entity relationships such as sensitive entity relationships 135, resulting in base large language model 160 also excluding sensitive entity relationships after training. To perform fine tuning 170, machine learning system 100 may generate training data 150, in some embodiments. To generate training data 150, raw private data 130 may be obtained, where the raw data may include sensitive entity relationships, such as a relationship defined by verb 132 between entityA 131 and entityB 133. While the sensitive entity relationship shown in FIG. 1 includes a verb and two entities 131 and 132, it should be understood that other sensitive entity relationships may exist, including relationships include any number of entities, in various embodiments. The machine learning system 100 may process private data 130 to identify sensitive entity relationships 135 using entity tagging 190 according to one or more databases of sensitive relationship databases 195, then replace one of more of the respective entities of sensitive entity relationships with replacement entities according to a reference model 140. In some embodiments, reference model 140 may be a stock language model, like GPT, trained on the task of next word prediction while in other embodiments reference model 140 may be partially, or in whole, derived from base large language model 160 which may exclude sensitive entity relationships while in still other embodiments reference model 140 may be trained separately using non-sensitive data. For example, entityA 131 may be replaced with entity 151 and entity 133 replaced with 153 to generate a desensitized entity relationship 155. Once modifications to the private data 130 are complete, the training data 150, with sensitive entity relationships masked, may be used to fine-tune base large language model 160, in some embodiments.

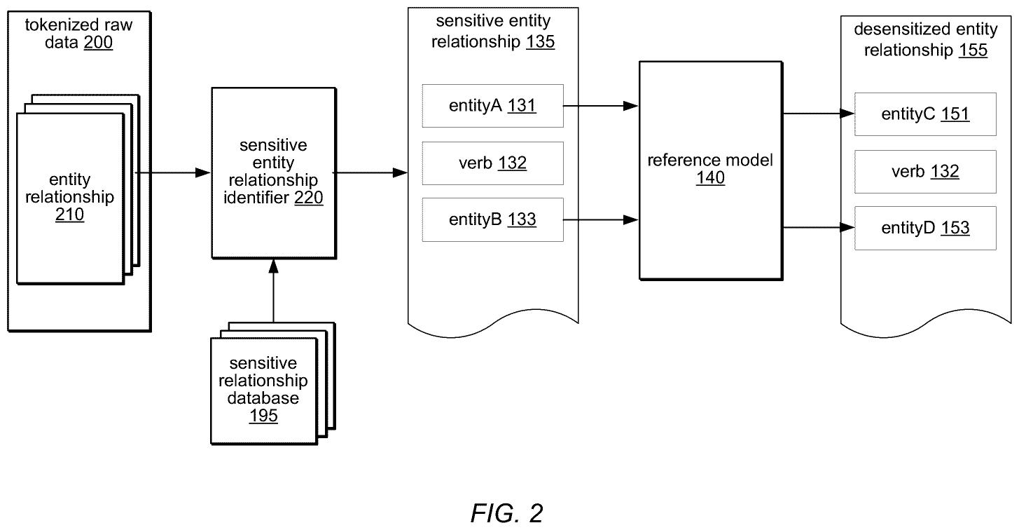

FIG. 2 is a block diagram illustrating sensitive entity modification in a machine learning system that provides entity-relationship privacy for large language models, in various embodiments. In at least one embodiment, to perform fine tuning, a machine learning system may generate training data using raw data, such as raw private data 130 of FIG. 1, that may include sensitive entity relationships, such as a sensitive entity relationship 135 defined by verb 132 between entityA 131 and entityB 133. In at least one embodiment, sensitive entity relationship 135 may be identified by tokenizing the raw data to generated tokenized raw data 200 and entity tagging the tokenized data, such as by using entity tagging 190 of FIG. 1, to generate various entity relationships 210. Sensitive entity relationships, such as sensitive entity relationship 135, may then be identified according defined sensitive relationships such as provided by one or more sensitive relationship databases 195. In at least one embodiment, sensitive relationship database(s) 195 may be included as part of machine learning system 100 (not shown) while in other embodiments sensitive relationship database(s) 195 may be provided through external sources, such as in the case of domain-specific or application-specific sensitive entity relationships. These examples are not intended to be limiting and various sources of sensitive relationship databases may be envisioned.

In at least one embodiment, sensitive relationships may be defined in a number of ways. For example, in at least one embodiment a datum may be identified as sensitive if it appears less than a threshold number of times in a training dataset. Correspondingly, frequency of occurrence of an entity relationship sequence may serve as a proxy for data sensitivity and use memorization measurement through template-based and prompt-based inference attacks to approximate privacy risks. Additionally, memorization across token-level and document-level settings may be measured.

However, metrics based on eidetic memorization have two restrictions. First, they build on the intuition that frequency of occurrence of a sequence may determine if a sequence is sensitive. However, frequency does not fully capture the sensitivity of data, often times infrequently occurring data is not sensitive. Furthermore, in domain-specific or application-specific tuning datasets, sensitive information, for example clinical notes on a patient with a terminal disease, may occur frequently. Second, eidetic memorization metrics are based on the extracting sequences used for training verbatim. However, natural language is rich enough to express the same sensitive data in varied forms, via various levels of indirection and associations. Verbatim memorization may not capture this semantic memorization that may occur in LLMs using sensitive training datasets.

In at least one embodiment, another technique for identifying sensitive entity relationships may focus on tokens in text data that embody Personally Identifiable Information (PII). Entity occurrences embodying PII in text data, however, are not sensitive all the time. Consider the following sentences:
“Dr. John Smith likes cats.” “Dr.
John Smith studies leukemia.” “Dr.
John Smith has leukemia.”

The first two sentences may be considered non-sensitive while the last sentence is sensitive, its key difference from the second sentence is the “has” relation between entities “John Smith” and “leukemia”. Sensitivity of relationships between entities appearing in the text data are therefore potentially dependent on the entities themselves and of the relationships between them. In the degenerate case, a simple mention of an entity may be viewed as sensitive data (e.g. data corpus containing list of leukemia patients). This can be correctly captured by the “exists” relationship between the entity and the enclosing context.

In at least one embodiment, various techniques for identifying sensitive entity relationships such as those discussed above may be integrated into sensitive relationship databases 195 which may then be used by sensitive entity relationship identifier 220 to identify sensitive entity relationship 135 defined by verb 132 between entityA 131 and entityB 133. Then, in at least one embodiment, one of more of the respective entities of respective sensitive entity relationships may be replaced with replacement entities generated according to a reference model 140. In some embodiments, reference model 140 may be partially, or in whole, derived from base large language model 160 which may exclude sensitive entity relationships while in other embodiments may be trained separately using non-sensitive data. For example, entityA 131 may be replaced with entity 151 and entity replaced with 153 to generate a desensitized entity relationship 155.

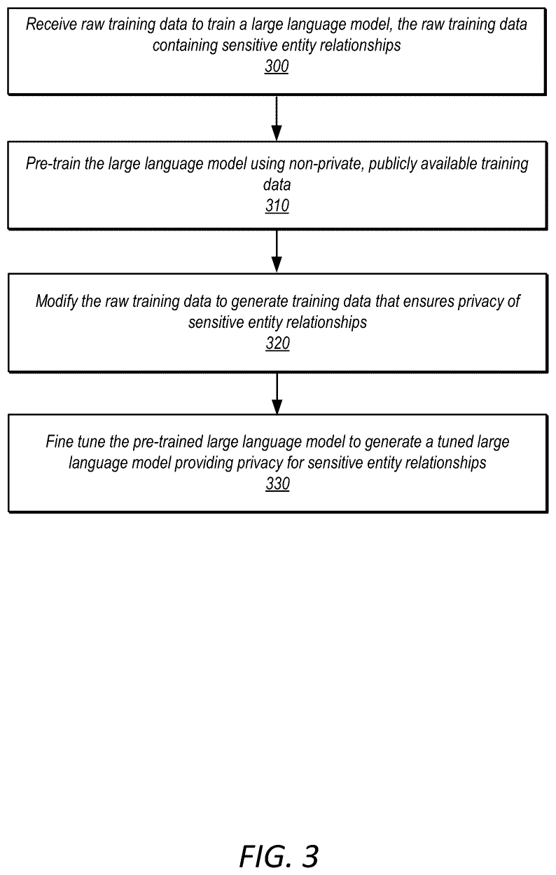

FIG. 3 is a high-level flowchart illustrating techniques for fine tuning the training of a large language model while enforcing entity relationship privacy, according to some embodiments. The process begins at 300 where raw training data, such as the private data 130 of FIG. 1, may be obtained to train a large language model, such as the fine-tuned large language model 180 of FIG. 1. This raw training data may contain sensitive entity relationships, such as the sensitive entity relationships 135.

As shown in step 310, a large language model may first be pre-trained with non-private publicly accessible data, in some embodiments. For example, non-private data, such as the non-private data 110 of FIG. 1, may be used to generate a large language model, such as base large language model 160 of FIG. 1, through pre-training such as the pre-training 120 of FIG. 1. In at least one embodiment, non-private data 110 may exclude sensitive entity relationships such as sensitive entity relationships 135, resulting in base large language model 160 also excluding sensitive entity relationships after training.

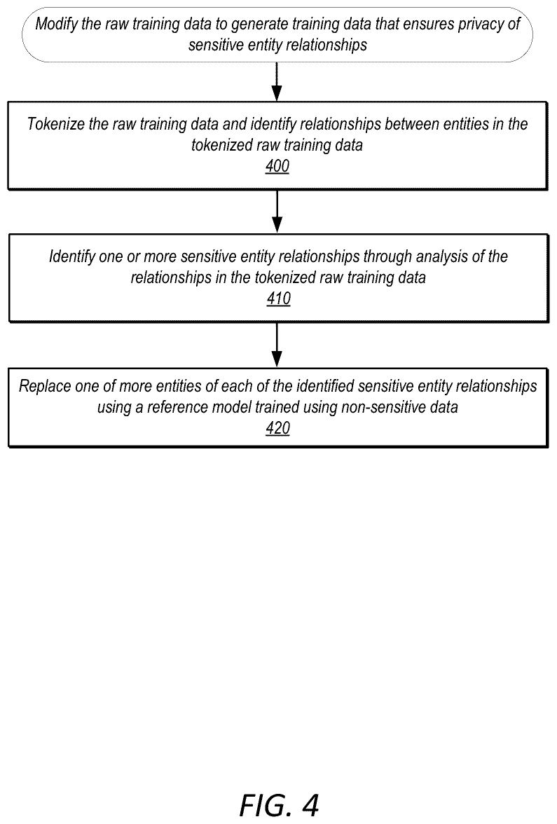

As shown in 320, the raw training data, such as the private data 130 of FIG. 1, may be modified to generate training data, such as the training data 150 of FIG. 1, that ensures privacy for sensitive entity relationships. This process is discussed in further detail in FIG. 4 below.

Then, as shown in 330, the generated training data may be used to fine-tune the pre-trained large language model to generate a tuned large language model, such as the fine-tuned large language model 180 of FIG. 1, where the tuned large language model provides privacy for sensitive entity relationships.

FIG. 4 is a high-level flowchart illustrating techniques for generating a training data set providing entity-relationship privacy, according to some embodiments. As shown in 400, raw training data, such as the private data 130 of FIG. 1, may be tokenized to identify various entity relationships. Then, as shown in 410, in at least one embodiment various tools and methods, such as the entity tagging 190 of FIG. 1, may be envisioned to precisely (or conservatively) identify sensitive entity relationships, such as the sensitive entity relationships 130 of FIG. 1, according to general or domain-specific sensitive entity relationships databases such as sensitive relationship databases 195 of FIG. 1. These tools and methods may not cover all the entities in sensitive relationships in arbitrary datasets containing large volumes of unstructured data, however datasets constrained to specific domains or applications (e.g. health care) where the vocabulary, verbiage, and language idioms are limited in scope to make identification feasible. If the sensitive dataset is small enough a manual screening to mark entities of sensitive relationships may be feasible. Simple regular expression matching can also be used to identify entities in sensitive relationships in settings where the vocabulary is constrained enough. Furthermore, natural language processing tools such as NLTK and spaCy can be used to identify entities in the dataset. Additionally, more aggressive approaches that target contextual data (e.g. nouns, pronouns, adjectives, sentence subjects and objects, etc.) may be employed to enable highly conservative perturbation of input text sequences, at the cost of degradation of model utility.

Then, as shown in 420, one or more entities, such as entities 131 and 133 of FIG. 1, of identified sensitive relationships may be replaced with non-sensitive entities, such as entities 151 and 153 of FIG. 1, to desensitize the sensitive entity relationship. This replacement may be performed using a reference model trained using non-sensitive data, such as the reference model 150 of FIG. 1. The reference model can be a stock language model, like GPT, trained on the task of next word prediction. Given an input string s=<s1, e1, r, e2, s2>, where s1 is the prefix of s up to the tokens embodying the sensitive relationship r between entities e1 and e2, and s2 is the corresponding suffix of s, the method replaces at least one of entities e1 and e2 in the relationship with tokens generated by the reference model. The reference mode may be provided the string <s1> as its input to generate a new entity e′, after which the model may be provided the string <s1, e′, r> to generate e′, a replacement for entity e2. Thus, string s is substituted by string s′=<s1, e′, r, e′, s2> using the reference model. This string s′ may be considered a desensitized entity relationship. Note that simply replacing either e1 or e2 may also be sufficient to obfuscate the relationship <e1↔e2>. Such an approach applies to settings where appearance of PII (e.g. names of individuals) in the input string is acceptable as long as the sensitive relationship remains hidden (by replacing the other entity in the relationship). In yet other settings, replacing the tokens comprising PII of an entity (e.g. name of a person) mentioned in text may be accomplished using the reference model R.

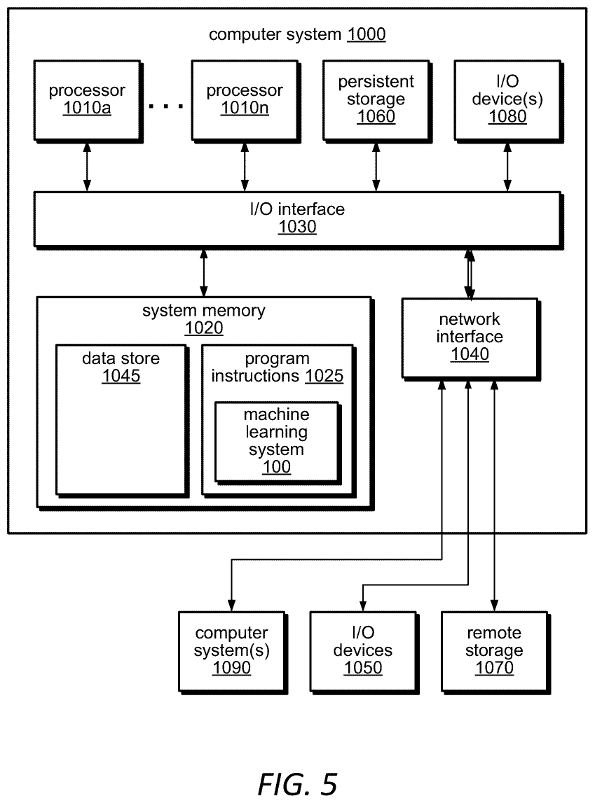

Various ones of the illustrated embodiments may include one or more computer systems 1000 such as that illustrated in FIG. 5 or one or more components of the computer system 1000 that function in a same or similar way as described for the computer system 1000.

In the illustrated embodiment, computer system 1000 includes one or more processors 1010 coupled to a system memory 1020 via an input/output (I/O) interface 1030. Computer system 1000 further includes a network interface 1040 coupled to I/O interface 1030. In some embodiments, computer system 1000 may be illustrative of servers implementing enterprise logic or downloadable applications, while in other embodiments servers may include more, fewer, or different elements than computer system 1000.

Computer system 1000 includes one or more processors 1010 (any of which may include multiple cores, which may be single or multi-threaded) coupled to a system memory 1020 via an input/output (I/O) interface 1030. Computer system 1000 further includes a network interface 1040 coupled to I/O interface 1030. In various embodiments, computer system 1000 may be a uniprocessor system including one processor 1010, or a multiprocessor system including several processors 1010 (e.g., two, four, eight, or another suitable number). Processors 1010 may be any suitable processors capable of executing instructions. For example, in various embodiments, processors 1010 may be general-purpose or embedded processors implementing any of a variety of instruction set architectures (ISAs), such as the x86, PowerPC, SPARC, or MIPS ISAs, or any other suitable ISA. In multiprocessor systems, each of processors 1010 may commonly, but not necessarily, implement the same ISA. The computer system 1000 also includes one or more network communication devices (e.g., network interface 1040) for communicating with other systems and/or components over a communications network (e.g. Internet, LAN, etc.). For example, a client application executing on system 1000 may use network interface 1040 to communicate with a server application executing on a single server or on a cluster of servers that implement one or more of the components of the embodiments described herein. In another example, an instance of a server application executing on computer system 1000 may use network interface 1040 to communicate with other instances of the server application (or another server application) that may be implemented on other computer systems (e.g., computer systems 1090).

System memory 1020 may store instructions and data accessible by processor 1010. In various embodiments, system memory 1020 may be implemented using any suitable memory technology, such as static random-access memory (SRAM), synchronous dynamic RAM (SDRAM), non-volatile/Flash-type memory, or any other type of memory. In the illustrated embodiment, program instructions and data implementing desired functions, such as those methods and techniques as described above for a machine learning system, as indicated at 100, for the downloadable software or provider network are shown stored within system memory 1020 as program instructions 1025. In some embodiments, system memory 1020 may include data store 1045 which may be configured as described herein.

In some embodiments, system memory 1020 may be one embodiment of a computer-accessible medium that stores program instructions and data as described above. However, in other embodiments, program instructions and/or data may be received, sent or stored upon different types of computer-accessible media. Generally speaking, a computer-accessible medium may include computer-readable storage media or memory media such as magnetic or optical media, e.g., disk or DVD/CD-ROM coupled to computer system 1000 via I/O interface 1030. A computer-readable storage medium may also include any volatile or non-volatile media such as RAM (e.g. SDRAM, DDR SDRAM, RDRAM, SRAM, etc.), ROM, etc., that may be included in some embodiments of computer system 1000 as system memory 1020 or another type of memory. Further, a computer-accessible medium may include transmission media or signals such as electrical, electromagnetic, or digital signals, conveyed via a communication medium such as a network and/or a wireless link, such as may be implemented via network interface 1040.

In one embodiment, I/O interface 1030 may coordinate I/O traffic between processor 1010, system memory 1020 and any peripheral devices in the system, including through network interface 1040 or other peripheral interfaces. In some embodiments, I/O interface 1030 may perform any necessary protocol, timing or other data transformations to convert data signals from one component (e.g., system memory 1020) into a format suitable for use by another component (e.g., processor 1010). In some embodiments, I/O interface 1030 may include support for devices attached through various types of peripheral buses, such as a variant of the Peripheral Component Interconnect (PCI) bus standard or the Universal Serial Bus (USB) standard, for example. In some embodiments, the function of I/O interface 1030 may be split into two or more separate components, such as a north bridge and a south bridge, for example. Also, in some embodiments, some or all of the functionality of I/O interface 1030, such as an interface to system memory 1020, may be incorporated directly into processor 1010.

Network interface 1040 may allow data to be exchanged between computer system 1000 and other devices attached to a network, such as between a client device and other computer systems, or among hosts, for example. In particular, network interface 1040 may allow communication between computer system 800 and/or various other device 1060 (e.g., I/O devices). Other devices 1060 may include scanning devices, display devices, input devices and/or other communication devices, as described herein. Network interface 1040 may commonly support one or more wireless networking protocols (e.g., Wi-Fi/IEEE 802.7, or another wireless networking standard). However, in various embodiments, network interface 1040 may support communication via any suitable wired or wireless general data networks, such as other types of Ethernet networks, for example. Additionally, network interface 1040 may support communication via telecommunications/telephony networks such as analog voice networks or digital fiber communications networks, via storage area networks such as Fibre Channel SANs, or via any other suitable type of network and/or protocol.

In some embodiments, I/O devices may be relatively simple or “thin” client devices. For example, I/O devices may be implemented as dumb terminals with display, data entry and communications capabilities, but otherwise little computational functionality. However, in some embodiments, I/O devices may be computer systems implemented similarly to computer system 1000, including one or more processors 1010 and various other devices (though in some embodiments, a computer system 1000 implementing an I/O device 1050 may have somewhat different devices, or different classes of devices).

In various embodiments, I/O devices (e.g., scanners or display devices and other communication devices) may include, but are not limited to, one or more of: handheld devices, devices worn by or attached to a person, and devices integrated into or mounted on any mobile or fixed equipment, according to various embodiments. I/O devices may further include, but are not limited to, one or more of: personal computer systems, desktop computers, rack-mounted computers, laptop or notebook computers, workstations, network computers, “dumb” terminals (i.e., computer terminals with little or no integrated processing ability), Personal Digital Assistants (PDAs), mobile phones, or other handheld devices, proprietary devices, printers, or any other devices suitable to communicate with the computer system 1000. In general, an I/O device (e.g., cursor control device, keyboard, or display(s) may be any device that can communicate with elements of computing system 1000.

The various methods as illustrated in the figures and described herein represent illustrative embodiments of methods. The methods may be implemented manually, in software, in hardware, or in a combination thereof. The order of any method may be changed, and various elements may be added, reordered, combined, omitted, modified, etc. For example, in one embodiment, the methods may be implemented by a computer system that includes a processor executing program instructions stored on a computer-readable storage medium coupled to the processor. The program instructions may be configured to implement the functionality described herein.

Various modifications and changes may be made as would be obvious to a person skilled in the art having the benefit of this disclosure. It is intended to embrace all such modifications and changes and, accordingly, the above description to be regarded in an illustrative rather than a restrictive sense.

Various embodiments may further include receiving, sending or storing instructions and/or data implemented in accordance with the foregoing description upon a computer-accessible medium. Generally speaking, a computer-accessible medium may include storage media or memory media such as magnetic or optical media, e.g., disk or DVD/CD-ROM, volatile or non-volatile media such as RAM (e.g. SDRAM, DDR, RDRAM, SRAM, etc.), ROM, etc., as well as transmission media or signals such as electrical, electromagnetic, or digital signals, conveyed via a communication medium such as network and/or a wireless link.

Embodiments of decentralized application development and deployment as described herein may be executed on one or more computer systems, which may interact with various other devices. FIG. 5 is a block diagram illustrating an example computer system, according to various embodiments. For example, computer system 1000 may be configured to implement nodes of a compute cluster, a distributed key value data store, and/or a client, in different embodiments. Computer system 1000 may be any of various types of devices, including, but not limited to, a personal computer system, desktop computer, laptop or notebook computer, mainframe computer system, handheld computer, workstation, network computer, a consumer device, application server, storage device, telephone, mobile telephone, or in general any type of compute node, computing node, or computing device.

In the illustrated embodiment, computer system 1000 also includes one or more persistent storage devices 1060 and/or one or more I/O devices 1080. In various embodiments, persistent storage devices 1060 may correspond to disk drives, tape drives, solid state memory, other mass storage devices, or any other persistent storage device. Computer system 1000 (or a distributed application or operating system operating thereon) may store instructions and/or data in persistent storage devices 1060, as desired, and may retrieve the stored instruction and/or data as needed. For example, in some embodiments, computer system 1000 may be a storage host, and persistent storage 1060 may include the SSDs attached to that server node.

In some embodiments, program instructions 1025 may include instructions executable to implement an operating system (not shown), which may be any of various operating systems, such as UNIX, LINUX, Solaris™, MacOS™, Windows™, etc. Any or all of program instructions 1025 may be provided as a computer program product, or software, that may include a non-transitory computer-readable storage medium having stored thereon instructions, which may be used to program a computer system (or other electronic devices) to perform a process according to various embodiments. A non-transitory computer-readable storage medium may include any mechanism for storing information in a form (e.g., software, processing application) readable by a machine (e.g., a computer). Generally speaking, a non-transitory computer-accessible medium may include computer-readable storage media or memory media such as magnetic or optical media, e.g., disk or DVD/CD-ROM coupled to computer system 1000 via I/O interface 1030. A non-transitory computer-readable storage medium may also include any volatile or non-volatile media such as RAM (e.g. SDRAM, DDR SDRAM, RDRAM, SRAM, etc.), ROM, etc., that may be included in some embodiments of computer system 1000 as system memory 1020 or another type of memory. In other embodiments, program instructions may be communicated using optical, acoustical or other form of propagated signal (e.g., carrier waves, infrared signals, digital signals, etc.) conveyed via a communication medium such as a network and/or a wireless link, such as may be implemented via network interface 1040.

It is noted that any of the distributed system embodiments described herein, or any of their components, may be implemented as one or more network-based services. For example, a compute cluster within a computing service may present computing services and/or other types of services that employ the distributed computing systems described herein to clients as network-based services. In some embodiments, a network-based service may be implemented by a software and/or hardware system designed to support interoperable machine-to-machine interaction over a network. A network-based service may have an interface described in a machine-processable format, such as the Web Services Description Language (WSDL). Other systems may interact with the network-based service in a manner prescribed by the description of the network-based service's interface. For example, the network-based service may define various operations that other systems may invoke and may define a particular application programming interface (API) to which other systems may be expected to conform when requesting the various operations.

In various embodiments, a network-based service may be requested or invoked through the use of a message that includes parameters and/or data associated with the network-based services request. Such a message may be formatted according to a particular markup language such as Extensible Markup Language (XML), and/or may be encapsulated using a protocol such as Simple Object Access Protocol (SOAP). To perform a network-based services request, a network-based services client may assemble a message including the request and convey the message to an addressable endpoint (e.g., a Uniform Resource Locator (URL)) corresponding to the network-based service, using an Internet-based application layer transfer protocol such as Hypertext Transfer Protocol (HTTP).

In some embodiments, network-based services may be implemented using Representational State Transfer (“RESTful”) techniques rather than message-based techniques. For example, a network-based service implemented according to a RESTful technique may be invoked through parameters included within an HTTP method such as PUT, GET, or DELETE, rather than encapsulated within a SOAP message.

Although the embodiments above have been described in considerable detail, numerous variations and modifications may be made as would become apparent to those skilled in the art once the above disclosure is fully appreciated. It is intended that the following claims be interpreted to embrace all such modifications and changes and, accordingly, the above description to be regarded in an illustrative rather than a restrictive sense.

What is claimed:

1. A method, comprising:
modifying raw data comprising one or more sensitive entity relationships to generate training data providing privacy for the one or more sensitive entity relationships; and
fine-tuning a large language model (LLM) according to the generated training data, wherein the fine-tuned LLM excludes the one or more sensitive entity relationships.

2. The method of claim 1, further comprising:
training the LLM prior to fine-tuning the LLM using non-private data; and
deriving a reference model, subsequent to the training, based at least in part on the trained LLM, the derived reference model excluding the one or more sensitive entity relationships.

3. The method of claim 1, wherein the modifying comprises:
analyzing the raw data to identify the one or more sensitive entity relationships, the one or more sensitive entity relationships individually comprising two or more entities including a first entity and a second entity; and
replacing at least one of the two or more entities of individual ones of the one or more sensitive entity relationships with respective entities generated by a reference model to generate the training data.

4. The method of claim 3, wherein an entity relationship of the one or more sensitive entity relationships is determined to be sensitive based at least in part on the two or more entities respectively appearing in less than a threshold number of relationships in non-private training data of the reference model.

5. The method of claim 3, wherein the one or more sensitive entity relationships individually comprise a relationship between the respective first entity and the respective second entity defined by a verb, and wherein an entity relationship of the one or more sensitive entity relationships defined by the verb is determined to be sensitive based at least in part on the relationship between the respective first entity and the respective second entity.

6. The method of claim 1, wherein an entity relationship of the one or more sensitive entity relationships is determined according to one or more domain-specific or application-specific databases of sensitive entity relationships.

7. The method of claim 1, further comprising:
applying the fine-tuned LLM to generated one or more inferences, the one or more inferences providing privacy for the one or more sensitive entity relationships.

8. One or more non-transitory, computer-readable storage media, storing program instructions that when executed on or across a plurality of computing devices, cause the plurality of computing devices to implement a machine learning system performing:
modifying raw data comprising one or more sensitive entity relationships to generate training data providing privacy for the one or more sensitive entity relationships; and
fine-tuning a large language model (LLM) according to the generated training data, wherein the fine-tuned LLM excludes the one or more sensitive entity relationships.

9. The one or more non-transitory, computer-readable storage media of claim 8, wherein the modifying is performed according to a reference model pretrained to perform next word prediction, and wherein the machine learning system further performs:
training the LLM prior to fine-tuning the LLM using non-private data.

10. The one or more non-transitory, computer-readable storage media of claim 8, wherein the modifying comprises:
analyzing the raw data to identify the one or more sensitive entity relationships, the one or more sensitive entity relationships individually comprising a first entity and a second entity; and
replacing at least one of the first entity and second entity of individual ones of the one or more sensitive entity relationships with respective entities generated by a reference model to generate the training data.

11. The one or more non-transitory, computer-readable storage media of claim 10, wherein an entity relationship of the one or more sensitive entity relationships is determined to be sensitive based at least in part on the first entity and the second entity respectively appearing in less than a threshold number of relationships in non-private training data of the reference model.

12. The one or more non-transitory, computer-readable storage media of claim 10, wherein the one or more sensitive entity relationships individually comprise a relationship between the respective first entity and the respective second entity defined by a verb, and wherein an entity relationship of the one or more sensitive entity relationships defined by the verb is determined to be sensitive based at least in part on the relationship between the respective first entity and the respective second entity.

13. The one or more non-transitory, computer-readable storage media of claim 8, wherein an entity relationship of the one or more sensitive entity relationships is determined according to one or more domain-specific or application-specific databases of sensitive entity relationships.

14. The one or more non-transitory, computer-readable storage media of claim 8, the machine learning system further performing:
applying the fine-tuned LLM to generated one or more inferences, the one or more inferences providing privacy for the one or more sensitive entity relationships.

15. A machine learning system, comprising:
at least one processor; and
a memory storing program instructions that when executed cause the at least one processor to implement a training system configured to:
modify raw data comprising one or more sensitive entity relationships to generate training data providing privacy for the one or more sensitive entity relationships; and
fine-tune a large language model (LLM) according to the generated training data, wherein the fine-tuned LLM excludes the one or more sensitive entity relationships.

16. The machine learning system of claim 15, the training system further configured to:
train the LLM prior to fine-tuning the LLM using non-private data; and
derive a reference model, subsequent to the training, based at least in part on the trained LLM, the derived reference model excluding the one or more sensitive entity relationships.

17. The machine learning system of claim 15, wherein to modify raw data the training system is configured to:
analyze the raw data to identify the one or more sensitive entity relationships, the one or more sensitive entity relationships individually comprising a first entity and a second entity; and
replace at least one of the first entity and second entity of individual ones of the one or more sensitive entity relationships with respective entities generated by a reference model to generate the training data.

18. The machine learning system of claim 17, wherein an entity relationship of the one or more sensitive entity relationships is determined to be sensitive based at least in part on the first entity and the second entity respectively appearing in less than a threshold number of relationships in non-private training data of the reference model.

19. The machine learning system of claim 17, wherein the one or more sensitive entity relationships individually comprise a relationship between the respective first entity and the respective second entity defined by a verb, and wherein an entity relationship of the one or more sensitive entity relationships defined by the verb is determined to be sensitive based at least in part on the relationship between the respective first entity and the respective second entity.

20. The machine learning system of claim 15, wherein an entity relationship of the one or more sensitive entity relationships is determined according to one or more domain-specific or application-specific databases of sensitive entity relationships.
